(19) United States
(12) Patent Application Publication
(10) Pub. No.: US 2006/0182268 A1
(43) Pub. Date: Aug. 17, 2006

(54) Audio system

(76) Inventor: Trygve Frederik Marton, Oslo (NO)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/318,266

(22) Filed: Dec. 23, 2005

(30) Foreign Application Priority Data
Dec. 29, 2004 (NO) 20045702

(51) Int. Cl. H04M 9/08

(52) U.S. Cl. 379/406.08

(57) ABSTRACT

The present invention relates to an audio communication system and method with improved acoustic characteristics. In particular, the present invention discloses a system and a method for modifying the loudspeaker signal for allowing improved echo cancellation of the audio signal captured by the microphone without deteriorate the perceptual stereo (or multi channel) sound. The basic idea is to merge the signals from the different channels into a mono characteristic signal, still keeping sufficient spatial information to provide perceptual multi channel sound on the loud speaker.

### RELATED APPLICATION

This application claims priority under 35 U.S.C. § 119 or 365 to Norwegian Application No. 20045702, filed Dec. 29, 2004. The entire teachings of the above application are incorporated herein by reference.

### BACKGROUND OF THE INVENTION

In a conventional conferencing system, one or more microphones captures a sound wave at a far end site, and transforms the sound wave into a first audio signal. The first audio signal is transmitted to a near end side, where a television set or an amplifier and loudspeaker, reproduces the original sound wave by converting the first audio signal generated at the first site into the sound wave. The produced sound wave at the near end site, is captured partially by the audio capturing system at the near end site, converted to a second audio signal, and transmitted back to the system at the far end site. This problem of having a sound wave captured at one site, transmitted to another site, and then transmitted back to the initial site is referred to as acoustic echo. In its most severe manifestation, the acoustic echo might cause feedback sound, when the loop gain exceeds unity. The acoustic echo also causes the participants at both sites to hear themselves, making a conversation over the conferencing system difficult, particularly if there are delays in the system set-up, as is common in video conferencing systems. The acoustic echo problem is usually solved using an acoustic echo canceller, described below.

FIG. 1 shows an example of an acoustic echo canceller subsystem. At least one of the participant sites has the acoustic echo canceller subsystem in order to reduce the echo in the communication system. The acoustic echo canceller subsystem is a full band model of a digital acoustic echo canceller. A full band model processes a complete audio band (e.g., up to 20 kHz; for video conferencing the band is typically 7 kHz or higher, in audio conferencing the band is typically up to 3.4 kHz) of the audio signals directly.

As already mentioned, compensation of acoustic echo is normally achieved by an acoustic echo canceller. The acoustic echo canceller is a stand-alone device or an integrated part in the case of the communication system. The acoustic echo canceller transforms the acoustic signal transmitted from far end site to near end site, for example, using a linear/non-linear mathematical model and then subtracts the mathematically modulated acoustic signal from the acoustic signal transmitted from near end site to far end site. In more detail, referring for example to the acoustic echo canceller subsystem at the near end site in FIG. 1, the acoustic echo canceller includes digital/analog converter 2111, analog/digital converter 2113, mathematical acoustic modeller 2121 and residual echo masker 2122. The acoustic echo canceller passes the first acoustic signal from the far end site through the mathematical modeller of the acoustic system, calculates an estimate of the echo signal, subtracts the estimated echo signal from the second audio signal captured at near end site, and transmits back the second audio signal, less the estimated echo to far end site. The echo canceller subsystem of FIG. 1 also includes an estimation error, i.e., a difference between the estimated echo and the actual echo, to update or adapt the mathematical model to a background noise and changes of the environment, at a position where the sound is captured by the audio capturing device.

The model of the acoustic system used in most echo cancellers is a FIR (Finite Impulse Response) filter, approximating the transfer function of the direct sound and most of the reflections in the room. A full-band model of the acoustic system is relatively complex and processing power requiring, and alternatives to full-band models are normally preferred.

One way of reducing the processing power requirements of an echo canceller is to introduce sub-band processing, i.e. the signal is divided into bands with smaller bandwidth, which can be represented using a lower sampling frequency. An example of such system is illustrated in FIG. 2. The loudspeaker and microphone signals are divided by the respective analyze filters 4125, 4131 into sub bands, each representing a smaller range of frequencies of the original loudspeaker and microphones respectively. Similar echo cancelling and other processing 4100 are performed on each sub band, before all bands of the modified microphone are merged together to form the full band signal, by the synthesize filter 4127. The components of processing block 4100 include acoustic modeller 4121 and miscellaneous subband processing 4122 which process signals that include subband microphone signal with echo and noise 4132, subband echo estimate 4133, subband microphone signal with residual echo and noise 4134 and subband audio signal to be transmitted 4135.

The core component in an echo canceller is the already mentioned acoustic model (most commonly implemented by a FIR filter). The acoustic model attempts to imitate the transfer function of the far end signal from the loudspeaker to the microphone. This adaptive model is updated by gradient search algorithm. The algorithm tries to minimize an error function, which is the power of the signal after the echo estimate is subtracted. For a mono echo canceller, this solution works, it is a uniform and unique solution.

However, in high quality communications, it is often desirable to transmit and present high quality multi channel audio, e.g. stereo audio. Stereo audio includes audio signals from two separate channels representing different spatial audio from a certain sound composition. Loading the channels on each respective loudspeaker creates a more faithful audio reproduction, as the listeners will perceive a spatial difference between the audio sources from which the sound composition is created.

The signal that is played on one loudspeaker differs from the signal presented on the other loudspeaker(s). Thus, for a stereo (or multi channel) echo canceller, the transfer function from each respective speaker to the microphone needs to be compensated for. This is a somewhat different situation compared to mono audio echo cancellation, as there are two different, but correlated signals to compensate for.

Note that transmission of stereo signals, by using several microphones, does not require stereo echo cancelling if only one loudspeaker (or mono presentation signal) is present. If multi channel audio should be recorded, the algorithms (both in prior art and in the invention) can be duplicated, and sometimes simplified (because many parts are common to all microphones). The duplication is straightforward, also in the case of stereo or multichannel reception of signals, and this document does not discuss the usage of more microphones in detail.

In stereo audio, the correlation in the different channels tends to be significant. This causes the normal gradient search algorithms to suffer. Mathematically expressed, the correlation introduces several false minimum solutions to the error function. This is i.a. described in Steven L. Gat and Jacob Boniest. “Acoustic signal processing for telecomrnunication”, Boston: Kluwer Academic Publishers, 2000. The fundamental problem is that when multiple channels carry linearly related signals, the solution of the normal function corresponding to the error function solved by the adaptive algorithm is singular. This implies that there is no unique solution to the equation, but an infinite number of solutions, and it can be shown that all but the true one depend on the impulse responses of the transmission room (in this context, the transmission room may also include a synthesized transmission room as e.g. recorded or programmed material played back at the far-end side). The gradient search algorithm may then be trapped in a minimum that not necessarily is the true minimum solution.

Another common way of expressing this stereo echo canceller adaptation problem is that it is difficult to distinguish between a room response change and an audio “movement” in the stereo image. For example, the acoustic model has to reconverge if one talker starts speaking at a different location at the far end side. There is no adaptive algorithm that can track such a change sufficiently fast, and a mono echo canceller in the multi-channel case does not result in satisfactory performance.

A typical approach for overcoming the above-mentioned false minimum solutions problem mentioned above is shown in FIG. 3. Compared to the mono case, the analyze filter is duplicated, dividing both the right and left loudspeaker signal into sub bands. The acoustic model is divided into two models (per sub band), one for the right channel transfer function and one for the left channel transfer function.

To overcome the false minimum solutions introduced by the correlation between the left and right channel signals, a de-correlation algorithm is introduced. This de-correlation makes it possible to correctly update the acoustic models. However, the de-correlation technique also modifies the signals that are presented on the loudspeakers. While quality preserving modification techniques could be acceptable, most de-correlation techniques according to prior art severely distort the audio. In addition, computationally inexpensive adaptive algorithms like the LMS (least mean square) or NLMS (normalized least mean square) tend to converge slow for stereo signals de-correlated using prior art. Therefore, prior art solution most commonly uses more computationally expensive algorithms, for example the RLS (recursive least square).

“Stereophonic acoustic echo cancellation using nonlinear transformation and comb filtering” Jacob Boniest et al, Bell Laboratories, Lucent Technology, describes a stereo receiving audio system partly using comb filtering on stereo input signals to de-correlate the channels allowing rapidly converging adaptive algorithms in the echo canceller module. However, due to the required complexity, it is still too computationally expensive.

Prior art techniques may solve the stereo echo problem, but they do not preserve the necessary quality of the audio, and in addition, the techniques are computationally intensive, due to the duplication of echo path estimation and other sub functions, and due to the more complex adaptive algorithms necessary.

### SUMMARY OF THE INVENTION

The present invention relates to an audio communication system and method with improved acoustic characteristics, and particularly to a conferencing system including improved audio echo cancellation characteristics.

It is an object of the present invention to provide a system and method minimizing audio echo when stereo is present.

In particular, the present invention discloses an audio system at a near-end conference party configured to receive a multi-channel audio signal from a far-end conference party and presenting corresponding audio on multiple loud speakers, capturing near-end audio by one or more microphones and transmitting corresponding near-end audio signal to the far-end conference party, including a merging unit configured to merge the multi-channel audio signal to a mono signal preserving spatial audio information, a preload unit configured to provide the audio on the multiple loud speakers, and a mono echo canceller using said mono signal as reference signal in generating an echo model signal being subtracted from the near-end audio signal before transmission to the far-end conference party.

A method corresponding to the audio system is also disclosed.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a detailed block diagram of a conventional conferencing system set-up.

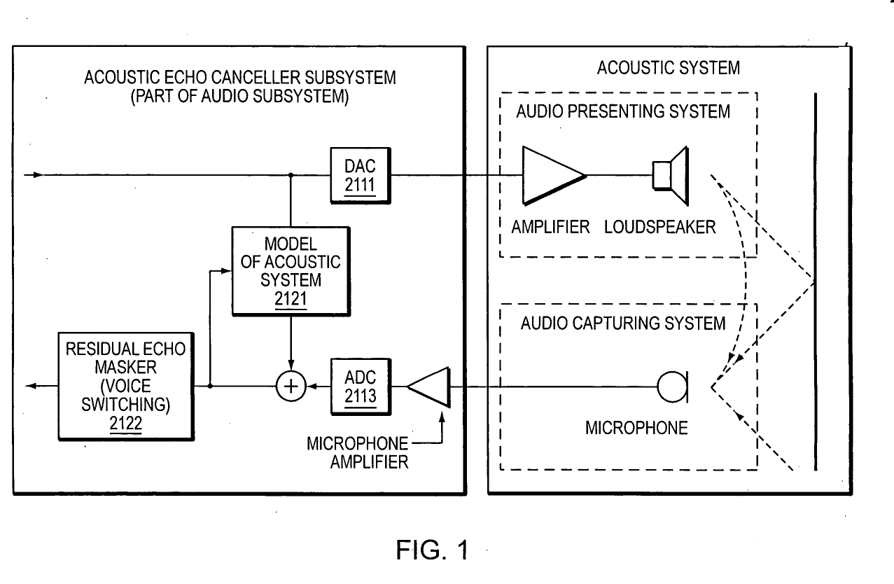

FIG. 2 is a block diagram of the corresponding echo canceller subsystem implemented with sub-band processing.

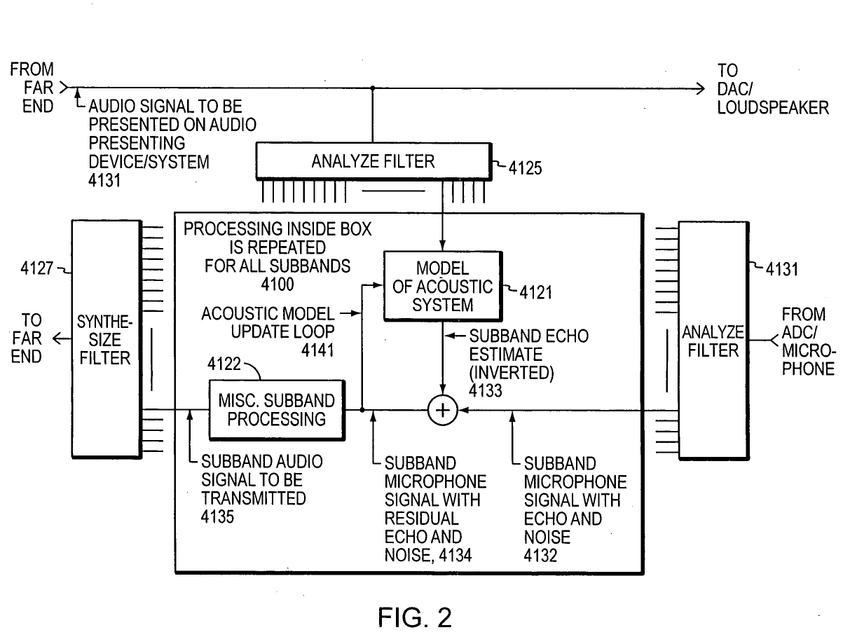

FIG. 3 is a block diagram of a stereo echo canceller system according to prior art.

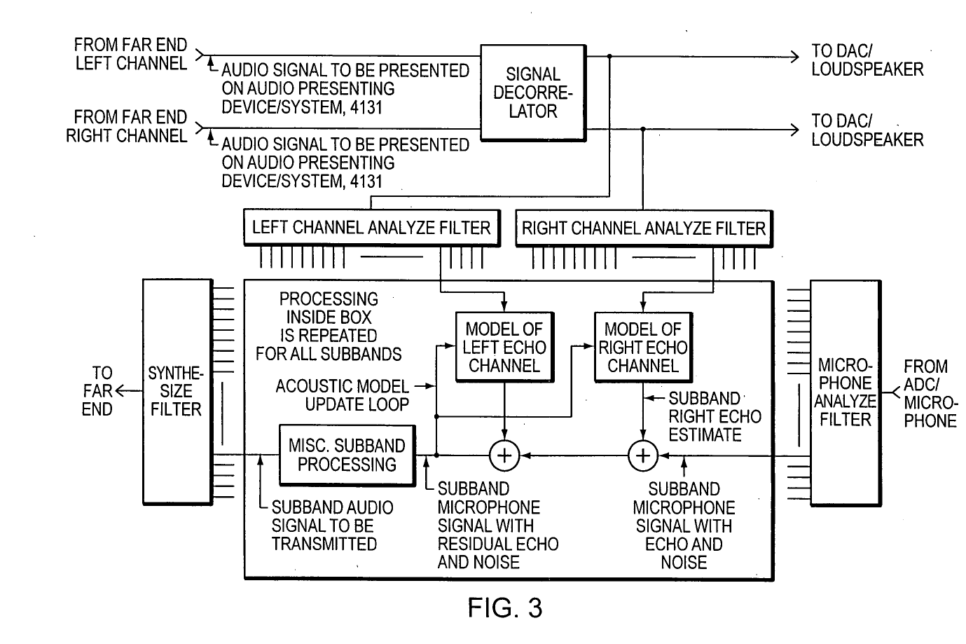

FIG. 4 is a block diagram of a general embodiment of the present invention.

FIG. 5 is a is a block diagram of a first preferred embodiment of the present invention.

FIG. 6 illustrates the frequency response of filters used in the first and the second preferred embodiment of the present invention.

FIG. 7 is a is a block diagram of a second preferred embodiment of the present invention.

FIG. 8 is a is a block diagram of a third preferred embodiment of the present invention.

### DETAILED DESCRIPTION OF THE INVENTION

In the following, the present invention will be discussed by describing preferred embodiments, and by referring to the accompanying drawings. However, even if the specific embodiments are described in connection with video conferencing and stereo sound, people skilled in the art will realize other applications and modifications within the scope of the invention as defined in the enclosed independent claims.

In particular, the present invention discloses a system and a method for modifying the loudspeaker signal for allowing improved echo cancellation of the audio signal captured by the microphone without deteriorating the perceptual stereo (or multi channel) sound. The basic idea is to merge the signals from the different channels into a mono characteristic signal, still keeping sufficient spatial information to provide perceptual multi channel sound on the loud speaker.

Both a generalized version for the multi channel case (including stereo) and preferred embodiments for the stereo embodiment introduce considerably less perceptual distortion to the audio signal than the de correlation algorithms according to prior art. It preserves the subjective stereo image, but still, using this invention, it is possible to cancel the echo using a mono echo canceller, and obtain an adequately high convergence speed using a computationally efficient LMS algorithm (more expensive and faster algorithms like APA and RLS can also be used, increasing the convergence speed). Therefore, compared to prior art, the invention also reduces complexity cost of the echo cancelling system, as the two path estimations in a stereo echo canceller can be replaced with one, usually less expensive single path estimator.

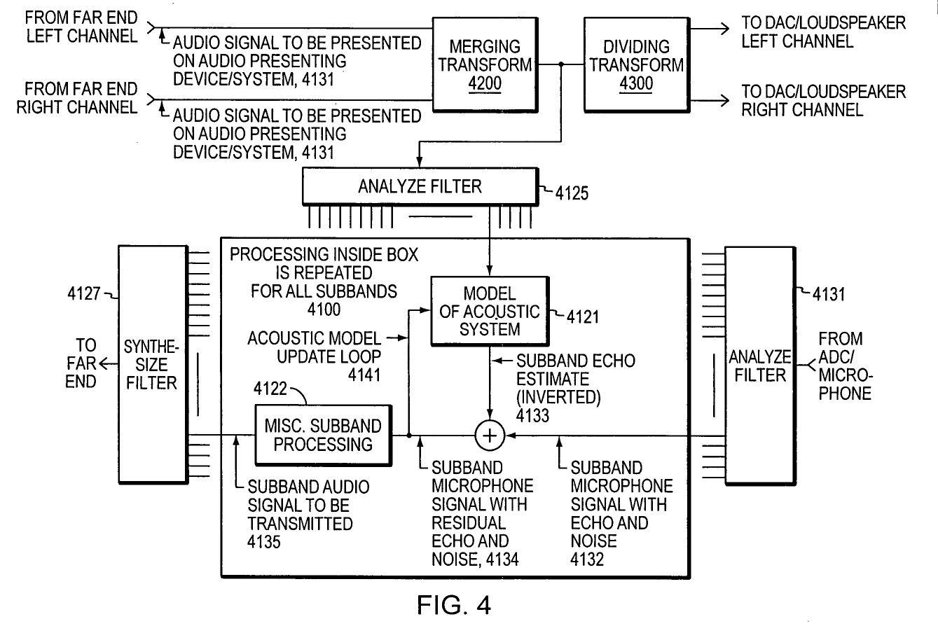

FIG. 4 shows a system illustrating the present invention in the general case. All (the left and right for stereo case) loudspeaker signals 4131 are passed through a merging transform 4200, combining the signals to one single mono signal. This single combined signal is used as the reference signal for a mono echo canceller.

The merging transform can be designed in various ways, and both non-linear and time variant techniques may be used, if desirable. The important point is that one single reference signal is made for the echo canceller, and that spatial audio information is preserved.

Further, before presenting the signals on the loudspeaker, the combined signal is divided into one signal for each loudspeaker by a dividing transform 4300. For a stereo case, the signal is divided into a left and a right channel.

The dividing transform constitutes a part of the echo response part that needs to be modeled. Therefore, care should be taken not to make a transform complicating the modeling. Standard echo cancellers usually estimates the echo response path using a linear model, therefore, a linear dividing transform is preferred. Echo cancellers also have to track any changes in the echo response path. This tracking is relatively slow, motivating the use of a time invariant dividing transform.

The merging and dividing transform must be configured to create a set of audio signal with the spatial information preserved, ensuring that they together limits the audible artifacts of the transformation.

From the echo cancellers point of view, when obtaining only one reference signal completely representing the load speaker signal, the signal is mono, even though the signal is divided and played on several loudspeakers. Therefore, by a proper selection of the merging and dividing transform, a signal with subjectively spatial information can be processed by a mono echo canceller.

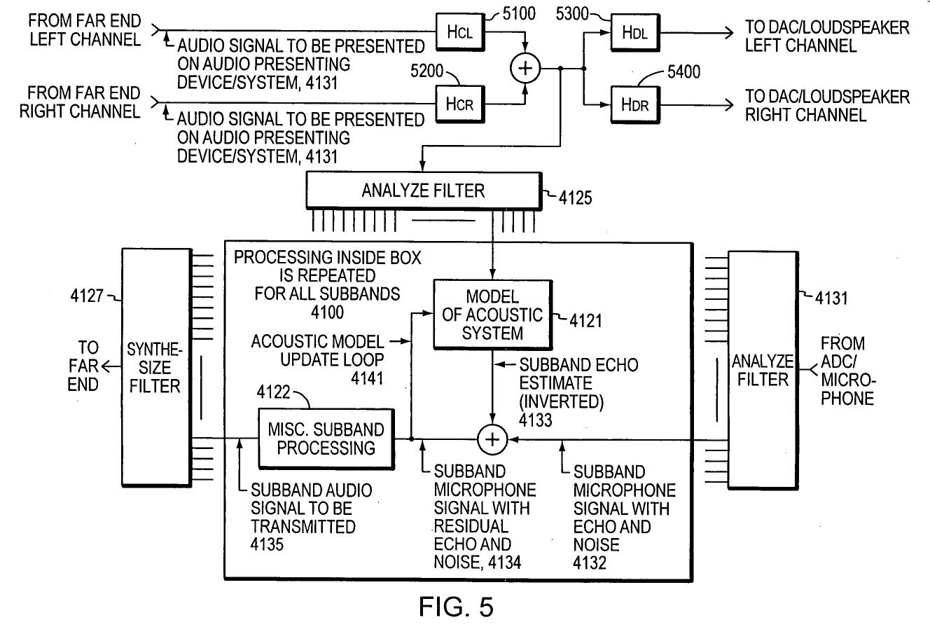

In FIG. 5, a general case of a preferred embodiment of a stereo (two channel) case is shown. The merging transform is formed by two linear filters H_{CL} 5100 and H_{CR} 5200, one for each channel, and an adder. The dividing transform is formed by another two linear filters H_{DL} 5300 and H_{DR} 5400.

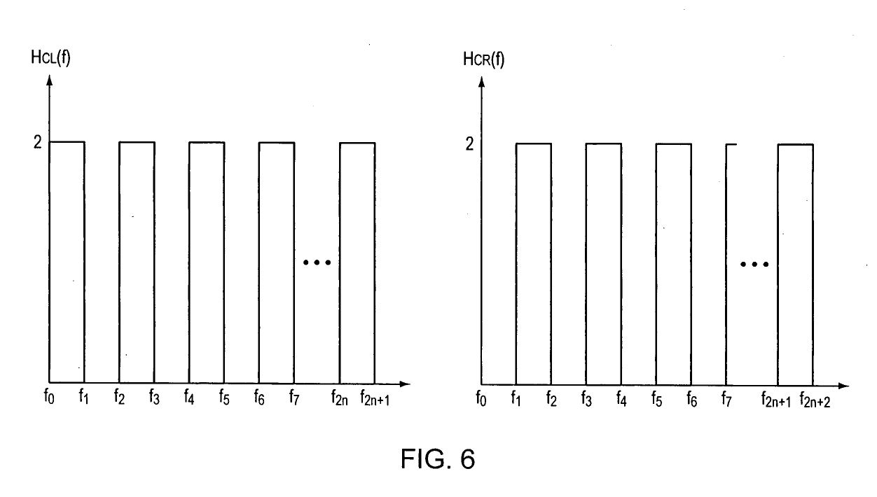

One set of filters preserving the spatial information only introducing limited perceptual degradation of the audio quality is the two complementary comb filters H_{CL} and H_{CR}:
H_{CL}(f)=K_{C} for fε[f₂ₙ,f₂ₙ₊₁>, 0 otherwise, and
H_{CR}(f)=K_{C} for fε[f₂ₙ₊₁,f₂ₙ₊₂>, 0 otherwise,

Where n=0, 1, 2 . . . . and fₙ are a freely selected set of frequencies. K_{C} is a gain to compensate for the loss introduced by the comb filtering. The frequency response two filters are illustrated in FIG. 6. Note that these are ideal filters, which practically are hard to achieve. However, it is possible to configure the filters to be to be complementary, even if they are not individually ideal.

The dividing transform has similar filters:
H_{DL}(f)=K_{D} for fε[f₂ₙ,f₂ₙ₊₁>, 0 otherwise, and
H_{DR}(f)=K_{D} for fε[f₂ₙ₊₁,f₂ₙ₊₂>, 0 otherwise,
for the same set of frequencies fₙ as for the merging transform. K_{D} is a gain to compensate for the loss introduced by the comb filtering. Usually, to maintain the energy through the system, K_{C}*K_{D} is usually selected to equal 2.

The merging filter removes half the frequency content in each channel to make the signals mergeable to a mono signal by an adder, which is provided as the reference signal for the echo canceller. The merged signal is then divided again by means of a dividing filter with respective frequency response corresponding to the merging filters, and the resulting left and right signal is loaded on the left and right loudspeaker.

The physical interpretation of the above formulas is that some frequency bands are played on the left loudspeaker, whereas the remaining frequency bands are played on the right loudspeaker. By making the frequency bands adequately narrow, the overall perception of audio quality and spatial information is good using naturally generated audio signals, which do not contain to many pure single tones. This is due to the properties of the ear. In addition, when played on a loud speaking system, the left and right channels will add almost completely before approaching the ears. Thus, the mono part (the sum of right and left channel) will be mixed back acoustically and therefore it will be very little degraded perceptually. The side part (the difference between the left and right channel) will be more affected, but still, experience has shown that the perception of spatiality is hardly reduced.

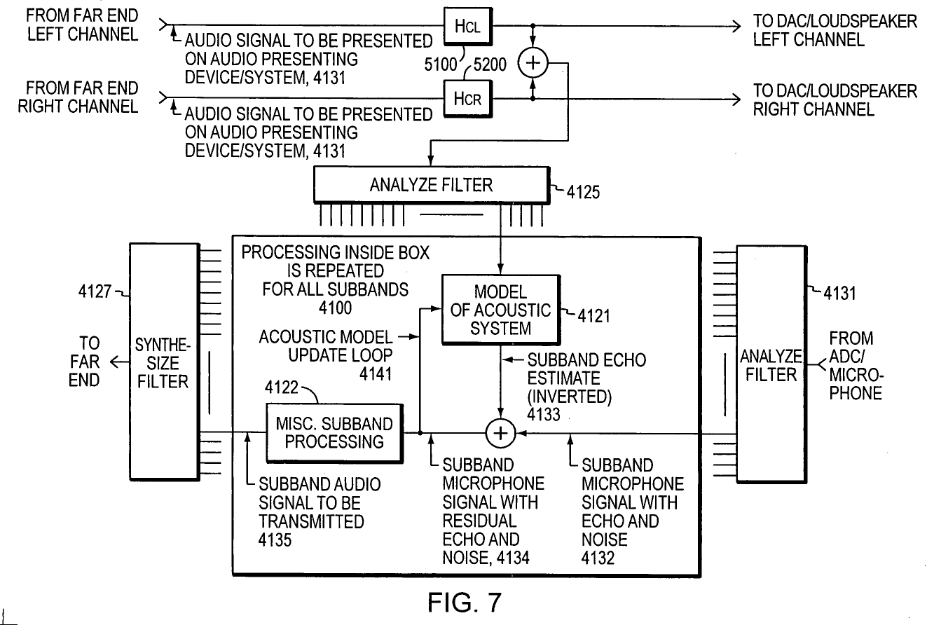

As already mentioned, it is hard to provide ideal filters as shown in FIG. 6, but if they are kept pretty close to ideal, the dividing filters can be omitted, and the systems complexity can be reduced to the one illustrated in FIG. 7. This deviates from the original structure presented, but it will still work, due to the complementary filters ensuring the cross paths to be zero gain, i.e. H_{CL}(f)*H_{DR}(f)=0 and H_{CR}(f)*H_{LL}(f)=0 at all frequencies. Of course, when omitting the dividing filters, the gain KD must be incorporated either in the merging filters or as a gain somewhere else in the system.

Practical implementations as the one described above will use equally broad frequency bands to avoid the need of a number of different filters (uniform filters) as many filter banks, including those used in most sub band echo cancellers, do have bands with identical bandwidth. However, the required frequency width of each “tooth” of the comb filters is actually frequency dependent. Low frequencies require more narrow “teeth” than high frequencies, and to comply with this criterion in a uniform comb filter, an impractically high number of “teeth” will be required. However, most often, very limited spatial information is present in the lower frequencies. Therefore, it may be advantageous to play the mono (i.e. sum signal) in all (both) channels at low frequencies, that is:
H_{CL}(f)=K_{MC} for fε[0,f₁>, K_{C} for fε[f₂ₙ₊₂,f₂₊₃>, 0 otherwise, and
H_{CR}(f)=K_{MC} for fε[0,f₁>, K_{C} for fε[f₂ₙ₊₁,f₂ₙ₊₂>, 0 otherwise,
H_{DL}(f)=K_{MD} for fε[0,f₁>, K_{D} for fε[f₂ₙ₊₂,f₂ₙ₊₃>, 0 otherwise, and
H_{DR}(f)=K_{MD} for fε[0,f>, K_{D} for fε[f₂₊₁,f₂ₙ₊₂>, 0 otherwise,
where n=0, 1, 2, 3, . . . and f n are a freely selected set of frequencies. K_{C} and K_{D} are gains to compensate for the loss introduced by the comb filtering. K_{C}*K_{D} usually equals 2 to maintain the gain through the system. K_{MC} and K_{MD} are gains selected to maintain the mono signal level, and K_{MC}*K_{MD} is usually selected as unity. The physical interpretation of this is that the low frequency part played on the loudspeakers are full band mono signals, while at higher frequencies, the left and right signals are filtered by complementary comb filters.

The comb filters described above are especially suitable when used together with a sub band echo canceller. As the analyze filters are constructed to divide a full band signal into frequency bands and the synthesize filters are designed to merge the sub bands back into a full band signal, the sub band canceller already has incorporated most of the processing blocks needed for implementing the comb filter structure.

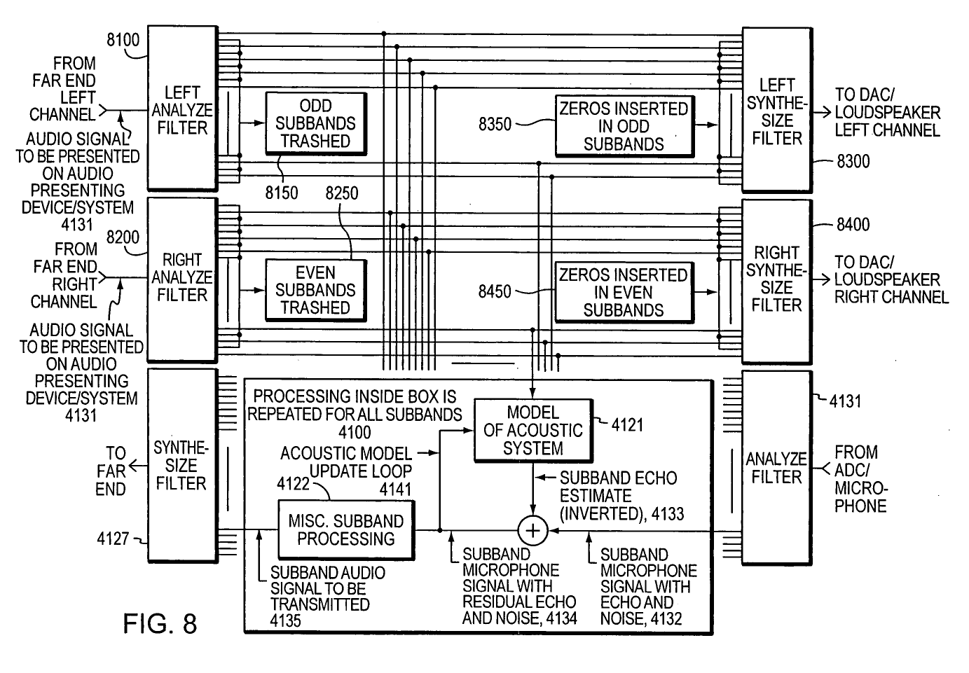

This is utilized in a preferred embodiment of the present invention, illustrated in FIG. 8. The left and right channel are individually divided into frequency bands representation Li and Ri using two instances of the analyze filter 8100, 8200. The two signals are then combined to a single reference signal Ci in the sub band domain:
Cᵢ=K_{CL,i}*Lᵢ+K_{CR,i}*Rᵢ
where K_{CL,i} and K_{CR,i} are weighting factors for left and right channel, respectively, and the letter i denotes the sub band number. The signal C is used as the input to the echo canceller as the loudspeaker reference signal.

Before playing the output signals, the reference signal is further divided into new left and right channel signals, Lᵢ′ and Rᵢ′ respectively:
Lᵢ′=K_{DL,i}*Cᵢ
Rᵢ′=K_{DR,i}*Cᵢ

Finally, these modified signals are processed through synthesize filters 8300, 8400 to make full band versions of the same. This process adds some delay, and as this delay is part of the echo path, it may be advantageous to delay the reference signal correspondingly, to avoid estimating non-causal filter taps in the response.

For a standard comb filtering structure, K_{CL,i}*K_{DL,i} are selected to equal 2 for i odd, and zero for i even, whereas K_{CR,i}*K_{DR,i} are selected to 0 for i odd, and 2 for i even. Combining the lower frequency bands to a mono signal, as suggested above, is also easily realizable, as is also any other thinkable combination. The merging and dividing constants can be chosen freely without worrying about the echo cancellers performance, as the analysing and synthesizing filter bank already incorporates adequately steep frequency band transitions. The merging constants may be time variant and/or non linear, if requested, whereas the dividing constants, constituting part of the path to be modelled, better are kept linear and time invariant.

As for the more general approach, if K_{CL,i}*K_{DR,I}=0 and K_{CR,i}*K_{DL,I}=0 for all i, the merging and dividing process can be replaced by simple copying/signal routing. A sub band canceller modified for implementing the merging and dividing filter structure as this are also shown in FIG. 8. The scaling factors compensating for the lost energy when clearing every other sub band, should be incorporated in the left/right analyze/synthesize filters, or somewhere else in the system. The figure shows the case where all even bands are extracted and used for the left channel and all odd bands from the right channel. Of course, the opposite will work just as well.

Except for the merging and dividing processes, which are both simple vector multiplications and additions, no new building blocks are added to a standard mono sub band echo canceller as using this structure, making the technique easy to implement.

Compared to realizations of stereo cancellers using de correlation techniques, two new synthesize filters must be added. However, due to one single reference vector, only one set of echo path models must be implemented. The processing power required for two synthesize filters is normally small compared to the processing power required for an additional echo path model set, thus, the processing power requirements for this approach is considerable smaller than for standard stereo echo cancellers. The audible artifacts are less noticeable than known de correlation techniques. The extra delay introduced in the loudspeaker signal path may be disadvantageous in some applications, whereas it in other applications (e.q. video conferencing, where the audio signal are delayed to achieve synchronization between audio and video) is uncritical.

One of the main advantages of the present invention is that it allows for handling a stereo audio signal with a mono echo canceller, with only minor changes to the canceller. Thus, the technique is fast to implement. It also utilizes building blocks in standard sub band cancellers.

Further, the present invention provides for considerable lower processing power demands than standard stereo echo cancellers, and it adds less audible degradation to the audio signal than stereo echo cancellers using known de correlation techniques.

While this invention has been particularly shown and described with references to preferred embodiments thereof, it will be understood by those skilled in the art that various changes in form and details may be made therein without departing from the scope of the invention encompassed by the appended claims.

What is claimed is:

1. An audio system at a near-end conference party configured to receive a multi-channel audio signal from a far-end conference party and presenting corresponding audio on multiple loud speakers, capturing near-end audio by one or more microphones and transmitting corresponding near-end audio signal to the far-end conference party, characterized in
a merging unit configured to merge the multi-channel audio signal to a mono signal preserving spatial audio information by providing frequency complementary filters on the multi channel audio, one for each channel, and by adding the channels after being filtered for creating said mono signal,
a preload unit configured to load audio on the multiple loud speakers by dividing said mono signal followed by filtering with frequency responses corresponding to said frequency complementary filters or by simply providing the multi-channel audio signal filtered with said frequency complementary filters on the multiple loud speakers,
a mono echo canceller using said mono signal as reference signal in generating an echo model signal being subtracted from the near-end audio signal before transmission to the far-end conference party.

2. An audio system according to claim 1, characterized in that said complementary frequency filters are filters with comb filter frequency responses.

3. An audio system according to claim 1, characterized in
a first analyze filter dividing said mono signal to a number of sub-band mono signals, wherein said mono echo canceller is a sub-band echo canceller,
a second analyze filter dividing the near-end audio signal to a number of near-end audio sub-signals, wherein said echo model signal is a sub-band echo model signal generated by said sub-band echo canceller,
a first synthesis filter merging said number of near-end audio sub-signals, after subtracting said sub-band echo model signal from a corresponding one of said number of near-end audio sub-signals, and before transmission to the far-end conference party.

4. An audio system according to claim 1, characterized in that said preload unit concurs with said frequency complementary filters.

5. An audio system according to claim 1, characterized in that the multi channel signal is a stereo audio signal comprising a left (L) channel and a right ®) channel.

6. An audio system according to claim 5, characterized in that a first one of said frequency complementary filters associated with said L channel has a frequency response according to the following characteristics:
H_{L}(f)=K_{C} for fε[f₂ₙ,f₂ₙ₊₁>, 0 otherwise,
and a second one of said frequency complementary filters associated with said R channel has a frequency response of the following characteristics:
H_{R}(f)=K_{C} for fε[f₂ₙ₊₁,f₂ₙ₊₂>, 0 otherwise.

7. An audio system according to claim 5, characterized in that said frequency complementary filters includes a respective left and right analyze filter and that said preload unit includes a respective left and right synthesis filter, wherein even sub-band frequency outputs of said left analyze filter constitute even sub-band frequency inputs to said left synthesize filter, and wherein odd sub-band frequency outputs of said right analyze filter constitute odd sub-band frequency inputs to said right synthesize filter, and said adder is configured to respectively add an even sub-band frequency output of said left analyze filter with a corresponding odd sub-band frequency output of said right analyze filter creating a corresponding sub-band mono signal, which constitute said mono signal being used as said reference signal provided to a corresponding sub-band mono echo canceller, which constitutes said mono echo canceller.

8. A method in an audio system at a near-end conference party receiving a multi-channel audio signal from a far-end conference party and presenting corresponding audio on multiple loud speakers, capturing near-end audio by one or more microphones and transmitting corresponding near-end audio signal to the far-end conference party, characterized in
merging the multi-channel audio signal to a mono signal preserving spatial audio information by filtering the multi-channel audio by frequency complementary filters, one for each channel of the multi channel audio, and by adding the channels after being filtered by the frequency complementary filters for creating said mono signal,
providing the audio on the multiple loud speakers by dividing said mono signal followed by filtering with frequency responses corresponding to said frequency complementary filters, or by simply providing the multi-channel audio signal filtered with said frequency complementary filters on the multiple loud speakers,
using said mono signal as reference signal in a mono echo canceller for generating an echo model signal being subtracted from the near-end audio signal before transmission to the far-end conference party.

9. A method according to claim 8, characterized in that said complementary frequency filters are filters with comb filter frequency responses.

10. A method according to claim 8, characterized in the following additional steps:
dividing said mono signal to a number of sub-band mono signals by a first analyze filter, wherein said mono echo canceller is a sub-band echo canceller,
dividing the near-end audio signal to a number of near-end audio sub-signals by a second analyze filter, wherein said echo model signal is a sub-band echo model signal generated by said sub-band echo canceller,
merging said number of near-end audio sub-signals by a first synthesis filter, after subtracting said sub-band echo model signal from a corresponding one of said number of near-end audio sub-signals, and before transmission to the far-end conference party.

11. A method according to claim 8, characterized in that said preload unit concurs with said frequency complementary filters.

12. A method according to claim 8, characterized in that the multi channel signal is a stereo audio signal comprising a left (L) channel and a right ®) channel.

13. A method according to claim 12, characterized in that a first one of said frequency complementary filters associated with said L channel has a frequency response according to the following characteristics:
H_{L}(f)=K_{C} for fε[f₂ₙ,f₂ₙ₊₁>, 0 otherwise,
and a second one of said frequency complementary filters associated with said R channel has a frequency response according to the following characteristics:
H_{R}(f)=K_{C} for fε[f₂ₙ₊₁,f₂ₙ₊₂>, 0 otherwise.

14. A method according to claim 12, characterized in that the step of filtering further includes the following additional step:
dividing said L channel by a left analyze filter to a number of left sub-band frequency outputs and said R channel by a right analyze filter to a number of right sub-band frequency outputs, the step of adding further includes the following additional step:
merging even left sub-band frequency outputs of said left analyze filter by a left synthesize filter and odd right sub-band frequency outputs of said right analyze filter by a right synthesize filter, the step of providing further includes the following additional step:
adding an even sub-band frequency output of said left analyze filter with a corresponding odd sub-band frequency output of said right analyze filter creating a corresponding sub-band mono signal, which constitutes said mono signal being used as said reference signal provided to a corresponding sub-band mono echo canceller, which constitutes said mono echo canceller.
